(19) United States
(12) Patent Application Publication
(10) Pub. No.: US 2026/0194369 A1
(43) Pub. Date: Jul. 9, 2026

(54) NON-CONTACT THREE-DIMENSIONAL DISPLACEMENT SENSOR

(71) Applicant: University of Science and Technology of China, Hefei (CN)

(72) Inventors: Zhihua Feng, Hefei (CN); Shuyu Zhu, Hefei (CN); Tao Xu, Hefei (CN); Zilong Feng, Hefei (CN); Rongjie Li, Hefei (CN)

(21) Appl. No.: 19/382,408

(22) Filed: Nov. 7, 2025

(30) Foreign Application Priority Data
Jan. 8, 2025 (CN) 202510027979.X

(51) Int. Cl. G01D 5/22

(52) U.S. Cl. CPC G01D 5/2266

(57) ABSTRACT

A non-contact three-dimensional displacement sensor is provided, including a mechanical probe and a detection circuit. The mechanical probe is primarily composed of a pair of differential helical excitation coils, a pair of metallic target conductors, and a pair of hash-shaped receiving coils fixed on surfaces of the pair of the metallic target conductors. The pair of the differential helical excitation coils and the pair of the metallic target conductors together form a differential eddy current sensor (ECS), and the pair of the differential helical excitation coils and the pair of the hash-shaped receiving coils constitute an inductive displacement sensor (IDS) based on a principle of mutual inductance, so as to enable displacement measurement along all three spatial directions (x, y, and z).

### TECHNICAL FIELD

The present disclosure relates to a technical field of sensors, and in particular to a non-contact three-dimensional (3D) displacement sensor based on a differential eddy current sensor and an inductive displacement sensor.

### BACKGROUND

With the development of industrial automation and intelligent manufacturing, demand for precision displacement measurement technology is daily increasing. As critical components in automated systems, performance of displacement sensors directly affects position control accuracy and system stability.

Non-contact displacement measurement is a very important direction in the development of displacement measurement technology. Compared with contact-type displacement sensors, non-contact displacement sensors are gaining increasingly widespread application because they have no direct mechanical coupling with a measured target, exhibit a small load effect, involve no wear during a measurement process, and offer long lifespan and high reliability. Especially for measurement of high-speed motion, the non-contact displacement sensors are the only choice.

Among various non-contact displacement sensors, inductive sensors measure displacements between coils based on an electromagnetic induction effect between the coils. Compared with capacitive displacement sensors and eddy current sensors, the inductive sensors detect the displacements between the coils by measuring mutual inductance between the coils, possessing characteristics such as high resolution, large measuring range, and a simple structure. Furthermore, since the mutual inductance between the coils is minimally sensitive to environmental factors such as humidity, the inductive sensors maintain good stability even in harsh environments.

Three-dimensional (3D) non-contact measurement has wide applications in many scenarios, for example, displacement feedback for a three-degree-of-freedom (x, y, z) displacement stage requires displacement measurements in all three directions. Conventional 3D displacement sensors often consist of a simple superposition of the same type of probes, such as eddy current sensors in all three directions. A disadvantage of this approach is that a measuring range in all three directions is relatively small. Alternative solutions, such as selecting a laser interferometer, lead to high costs; choosing a laser displacement sensor results in lower resolution; and opting for a strain gauge displacement sensor is a contact-type measurement with low resolution.

### SUMMARY

To address above drawbacks and deficiencies in the prior art, the present disclosure aims to provide a non-contact three-dimensional (3D) displacement sensor. The non-contact 3D displacement sensor organically integrates structures of a differential eddy current sensor (ECS) and an inductive displacement sensor (IDS) into a single unit. Such integration simplifies an overall structure of the non-contact 3D displacement sensor, reduces production and usage costs, enables simultaneous non-contact measurement of displacement in all three coordinate directions, inherently offers high bandwidth, and provides extremely low nonlinearity and excellent resolution within a measurement range of the non-contact 3D displacement sensor in all directions.

To solve above technical problems, the present disclosure adopts following technical solution.

The present disclosure provides the non-contact 3D displacement sensor, including a mechanical probe and a detection circuit. The mechanical probe includes a differential fixing block and a cantilever, the differential fixing block is U-shaped, and an end portion of the cantilever is suspended within inner sides of the differential fixing block. Two differential coils are respectively fixedly disposed on two parallel inner side surfaces of the differential fixing block, and the two differential coils include a first differential coil and a second differential coil. A first target conductor is fixedly disposed on a top surface of the end portion of the cantilever and is disposed directly below the first differential coil, and a second target conductor is fixedly disposed on a bottom surface of the end portion of the cantilever and is disposed directly above the second differential coil. A pair of first receiving coils is fixedly disposed along a horizontal X-direction on at least one of a top surface of the first target conductor and a bottom surface of the second target conductor, and a pair of second receiving coils is fixedly disposed along a horizontal Y-direction thereon. The first receiving coils of each pair are arranged parallel to each other, the second receiving coils of each pair are arranged parallel to each other, and the pair of the first receiving coils and the pair of the second receiving coils are arranged perpendicular to each other to form a grid pattern. When the first differential coil and the second differential coil are in a state of being supplied with an excitation signal, and when relative displacement occurs between the differential fixing block and the cantilever, a difference between output signals respectively at an output terminal of the first differential coil and an output terminal of the second differential coil is demodulated by a measurement circuit to output a Z-direction displacement output voltage, the Z-direction displacement output voltage quantitatively represents a relative displacement between the cantilever and the differential fixing block in a Z-direction, and the Z-direction is perpendicular to the two parallel inner side surfaces of the differential fixing block. A difference between output signals respectively at output terminals of the two receiving coils of each pair is demodulated by the measurement circuit to respectively output an X-direction displacement output voltage and a Y-direction displacement output voltage, the X-direction displacement output voltage quantitatively represents a relative displacement between the cantilever and the differential fixing block in an X-direction, the Y-direction displacement output voltage quantitatively represents a relative displacement between the cantilever and the differential fixing block in a Y-direction, a plane defined by the X-direction and Y-direction is parallel to the two parallel inner side surfaces of the differential fixing block.

Furthermore, the first differential coil and the second differential coil have the same structure, each including a dual-layer stacked configuration with series connected windings arranged end to end.

Furthermore, the detection circuit includes an excitation power supply, a differential amplifier, an X-direction instrumentation amplifier, a Y-direction instrumentation amplifier, a Z-direction phase-sensitive detector, an X-direction phase-sensitive detector, and a Y-direction phase-sensitive detector. A first terminal of the first differential coil and a first terminal of the second differential coil are both grounded, a second terminal of the first differential coil and a second terminal of the second differential coil are respectively connected in series with first terminals of two matching resistors, and second terminals of the two matching resistors are connected to an output terminal of the excitation power supply. Two connection points between the two differential coils and the two matching resistors are respectively connected to two signal input terminals of the differential amplifier, an output terminal of the differential amplifier and the output terminal of the excitation power supply are respectively connected to two input terminals of the Z-direction phase-sensitive detector, and the Z-direction phase-sensitive detector is configured to output the Z-direction displacement output voltage. First terminals of the pair of the first receiving coils and first terminals of the pair of the second receiving coils are grounded, and second terminals of the pair of the first receiving coils and second terminals of the pair of the second receiving coils are respectively connected to two input terminals of the X-direction instrumentation amplifier and two input terminals of the Y-direction instrumentation amplifier. An output terminal of the X-direction instrumentation amplifier, an output terminal of the Y-direction instrumentation amplifier, and the output terminal of the excitation power supply are respectively connected to two input terminals of the X-direction phase-sensitive detector and two input terminals of the Y-direction phase-sensitive detector, the X-direction phase-sensitive detector is configured to output the X-direction displacement output voltage, and the Y-direction phase-sensitive detector is configured to output the Y-direction displacement output voltage.

Furthermore, an output terminal of each of the Z-direction phase-sensitive detector, the X-direction phase-sensitive detector, and the Y-direction phase-sensitive detector is connected to a low-pass filter.

Furthermore, within a Z-direction detection stroke, a resistance variation for both the first differential coil and the second differential coil is ΔR, and an inductance variation for both the first differential coil and the second differential coil is ΔL, but a variation direction of the first differential coil and a variation direction of the second differential coil are opposite, such that a differential output voltage of U_{diff} from the first differential coil and the second differential coil of an alternating current (AC) bridge is expressed as follows:

$${U}_{diff} = \frac{2 \tilde{e} {R}_{s} ( - Δ R + j ω Δ L )}{( j ω ( L + Δ L ) + R + Δ R + {R}_{s} ) ( j ω ( L - Δ L ) + R - Δ R + {R}_{s} )} ; \qquad ( 1 )$$

the Z-direction displacement output voltage is expressed as follows:

$${U}_{z} = 2 {K}_{1} {K}_{2} Z ωΔ LE ; \qquad ( 2 )$$

$$Z \approx \frac{{R}_{s}}{\vert {( R + {R}_{s} )}^{2} - {ω}^{2} {L}^{2} + 2 j ω L ( R + {R}_{s} ) \vert} ; \qquad ( 3 )$$

specifically, E is an amplitude of an excitation voltage, ω is an angular frequency of the excitation voltage, K₁ is a signal gain of the differential amplifier, K₂ is a signal gain of the Z-direction phase-sensitive detector, Rs is a resistance value of each of the two matching resistors, R is an equivalent resistance of each of the first differential coil and the second differential coil, and L is an equivalent inductance of each of the first differential coil and the second differential coil.

Furthermore, the pair of first receiving coils and the pair of the second receiving coils respectively have mutual inductances of Mₓ and M_{y} with the first differential coil or the second differential coil; when an excitation current with a frequency of ω and an amplitude of I is applied to the first differential coil and the second differential coil, an induced voltage amplitude of Vₓ across the pair of the first receiving coils and an induced voltage amplitude of V_{y} across the pair of the second receiving coils are expressed as follows:

$$\{ \begin{matrix}{V}_{x} = ω {M}_{x} I \\ {V}_{y} = ω {M}_{y} I\end{matrix} ; \qquad ( 4 )$$

the X-direction displacement output voltage and the Y-direction displacement output voltage are expressed as follows:

$$\{ \begin{matrix}{U}_{x} = {K}_{3} {K}_{4} ω {M}_{x} I \\ {U}_{y} = {K}_{3} {K}_{4} ω {M}_{y} I\end{matrix} ; \qquad ( 5 )$$

specifically, K3 is a signal gain of each of the X-direction instrumentation amplifier and the Y-direction instrumentation amplifier, and K4 is a signal gain of each of the X-direction phase-sensitive detector and the Y-direction phase-sensitive detector.

Furthermore, the first target conductor and the second target conductor are both made of metal plates, in some embodiments, the first target conductor and the second target conductor are both made of aluminum plates.

Furthermore, in an initial state, a Z-direction distance between the first differential coil and the first target conductor is equal to a Z-direction distance between the second differential coil and the second target conductor, a Y-direction distance between the pair of the first receiving coils is equal to an X-direction distance between the pair of the second receiving coils, and an intersection point of centerlines of the pair of the first receiving coils and the pair of the second receiving coils is located on a line connecting centers of the first differential coil and the second differential coil.

Compared to the prior art, beneficial effects of the present disclosure are as follows.

The present disclosure organically integrates the ECS and the IDS into the single unit. Specifically, eddy current coils of the ECS also serves as excitation coils for the IDS, and metal targets required for probes of both the ECS and the IDS are combined into one. Such integration simplifies the overall structure of the non-contact 3D displacement sensor, thereby reducing the production and the usage costs.

The non-contact 3D displacement sensor of the present disclosure simultaneously measures displacement in all three coordinate directions without physical contact. A measurement range in X and Y-directions reaches 3 mm, with full-range nonlinearity as low as ±0.3%. A quasi-static resolution within a bandwidth of 0.1 to 10 Hz reaches 9 nm. A measurement range in a Z-direction is 200 μm, with a quasi-static resolution of 0.3 nm, and nonlinearity as low as +0.028%. Generally, there is no need to perform digital linearization on an output of the non-contact 3D displacement sensor, and the non-contact 3D displacement sensor inherently provides high bandwidth. The non-contact 3D displacement sensor achieves excellent performance with a very low nonlinearity and exceptional resolution in the Z-direction (the measurement range of 200 μm), while also providing a large range of up to 3 mm and nano-level resolution in the X and Y-directions, so that the non-contact 3D displacement sensor is highly versatile with a wide range of applications.

In the present disclosure, the X-direction instrumentation amplifier and the Y-direction instrumentation amplifier are directly connected to outputs of inductive receiving coils (the pair of the first receiving coils and the pair of the second receiving coils). A high input impedance of the X-direction instrumentation amplifier and the Y-direction instrumentation amplifier ensures that a current within the inductive receiving coils is nearly zero. With no current flowing, the inductive receiving coils do not generate a magnetic field, thus preventing any interference with signals of the eddy current coil and preserving performance of the probe of the ECS. This setup decouples measurements in the Z-direction from those in the X and Y-directions. Additionally, displacement sensitivity of the inductive receiving coils in the X and Y-directions is calibrated based on a Z-direction measurement obtained from the probe of the ECS, achieving final decoupling between the X, Y-directions and the Z-direction, so as to ensure stability and accuracy of measurement performance in each direction.

### BRIEF DESCRIPTION OF DRAWINGS

FIG. 1 is a structural schematic diagram of a non-contact three-dimensional (3D) displacement sensor of the present disclosure.

FIG. 2 is an exploded structural schematic diagram of the non-contact 3D displacement sensor of the present disclosure.

FIG. 3 is a simplified side-view structural schematic diagram of the non-contact 3D displacement sensor of the present disclosure.

FIG. 4 is a schematic diagram illustrating a structure and dimensions of a simulation model.

FIG. 5 is a top-view schematic diagram illustrating placement of inductive receiving coils on a first target conductor of the present disclosure.

FIG. 6A is a schematic diagram illustrating magnetic flux density distribution obtained from the simulation model.

FIG. 6B is a schematic diagram illustrating distribution of contour lines of magnetic flux density in a Z-direction obtained from the simulation model.

FIG. 7A is a schematic diagram illustrating a simulation result of inductance variation of a single-ended eddy current sensor (ECS) probe coil and a differential ECS coil within a measurement range of 200 μm near 0.6 mm from a surface of one target conductor.

FIG. 7B is a schematic diagram illustrating a simulation result of nonlinearity of the single-ended ECS probe coil and the differential ECS coil within the measurement range of 200 μm near 0.6 mm from the surface of the one target conductor.

FIG. 8A is a schematic diagram illustrating an effect trend of the number of turns of the inductive receiving coils on sensitivity and nonlinearity at a measurement range of ±1 mm.

FIG. 8B is a schematic diagram illustrating an effect trend of the number of turns of the inductive receiving coils on the sensitivity and nonlinearity at a measurement range of ±1.5 mm.

FIG. 8C is a schematic diagram illustrating an effect trend of the number of turns of the inductive receiving coils on the sensitivity and nonlinearity at a measurement range of ±2 mm.

FIG. 9A is a schematic diagram illustrating a trend of variation in maximum sensitivity of the inductive receiving coils at different measurement ranges.

FIG. 9B is a schematic diagram illustrating the number of turns corresponding to the maximum sensitivity of the inductive receiving coils.

FIG. 9C is a schematic diagram illustrating a trend of variation in minimum nonlinearity of the inductive receiving coils at different measurement ranges.

FIG. 9D is a schematic diagram illustrating the number of turns corresponding to the minimum nonlinearity of the inductive receiving coils.

FIG. 10A is a curve diagram illustrating magnetic flux distribution within a rectangular frame of the inductive receiving coils when a long side length 1 of the rectangular frame is equal to 22 mm under different offsets.

FIG. 10B is a curve diagram illustrating magnetic flux distribution within the rectangular frame of the inductive receiving coils when the long side length 1 of the rectangular frame is equal to 56 mm under different offsets.

FIG. 11 is a schematic diagram illustrating an effect trend of offsets in a Y-direction on X-direction displacement sensitivity of the inductive receiving coils.

FIG. 12 is a circuit schematic diagram of an ECS measurement circuit of the present disclosure.

FIG. 13 is a circuit schematic diagram of an inductive displacement sensor (IDS) measurement circuit of the present disclosure.

FIG. 14 is a structural schematic diagram of a phase-sensitive detection circuit based on an MC1496 balanced modulator-demodulator chip.

FIG. 15 is a schematic diagram of an equivalent model of a sensing process of the non-contact 3D displacement sensor.

FIG. 16 is a schematic diagram illustrating a simulation result of displacement sensitivities of inductive receiving coils of an IDS at different Z-direction distances.

FIG. 17 is a structural schematic diagram of a performance testing system used for measuring ECS sensitivity.

FIG. 18 is a schematic diagram illustrating a test result of Z-direction sensitivity of the non-contact 3D displacement sensor.

FIG. 19A is a schematic diagram illustrating a test result of z-direction output displacement noise of the non-contact 3D displacement sensor at a sampling rate of 600 Hz.

FIG. 19B is a schematic diagram illustrating a test result of z-direction output displacement noise of the non-contact 3D displacement sensor at a sampling rate of 10 Hz.

FIG. 20 is a structural schematic diagram of a performance testing system used for testing performance of the IDS.

FIG. 21A is a schematic diagram illustrating a test result of output of the inductive receiving coils in the Y-direction when displacement occurs in the Y-direction.

FIG. 21B is a schematic diagram illustrating a test result of output of the inductive receiving coils in the X-direction when displacement occurs in the X-direction.

FIG. 22A is a schematic diagram illustrating a test result of sensitivity of the inductive receiving coils when the number of turns of each of the inductive receiving coils is 15.

FIG. 22B is a schematic diagram illustrating a test result of sensitivity of the inductive receiving coils when the number of turns of each of the inductive receiving coils is 20.

FIG. 23A is a schematic diagram illustrating an experimental test result of output displacement noise of the IDS at a sampling rate of 600 Hz.

FIG. 23B is a schematic diagram illustrating an experimental test result of output displacement noise of the IDS at a sampling rate of 10 Hz.

The patent or application file contains at least one drawing executed in color, which is for illustrative purpose only and forms no part thereof.

Reference numerals in the drawings: 1. differential fixing block; 2. cantilever; 3. first differential coil; 4. second differential coil; 5. first target conductor; 6. second target conductor; 11. first base; 12. first cantilever beam; 13. second cantilever beam; 14. Z-axis rotary stage; 15. XY-direction displacement stage; 16. X-axis rotary stage; 17. Z-direction displacement stage; 21. piezoelectric displacement stage; 22. air-bearing platform; 23. clamping block; 24. test fixture; 25. second base.

### DETAILED DESCRIPTION OF EMBODIMENTS

Preferred embodiments of the present disclosure are described in detail below with reference to accompanying drawings, so that advantages and features of the present disclosure are more readily understood by those who skilled in the art, and a protection scope of the present disclosure is more clearly and precisely defined.

It should be noted that when a component is described as being “mounted on” another component, it may be directly mounted on the other component or indirectly mounted thereon through one or more intermediate components. When a component is described as being “disposed on” another component, it may be directly disposed on the other component or indirectly disposed thereon through one or more intermediate components. When a component is described as being “fixed to” another component, it may be directly fixed to the other component or indirectly fixed thereto through one or more intermediate components.

Unless otherwise defined, all technical and scientific terms used herein have the same meaning as commonly understood by those who skilled in the art to which the present disclosure pertains. Terminology used in description of the present disclosure is intended only to describe specific embodiments and is not intended to limit the protection scope of the present disclosure. As used herein, terms “and/or” include any and all combinations of one or more of associated listed items.

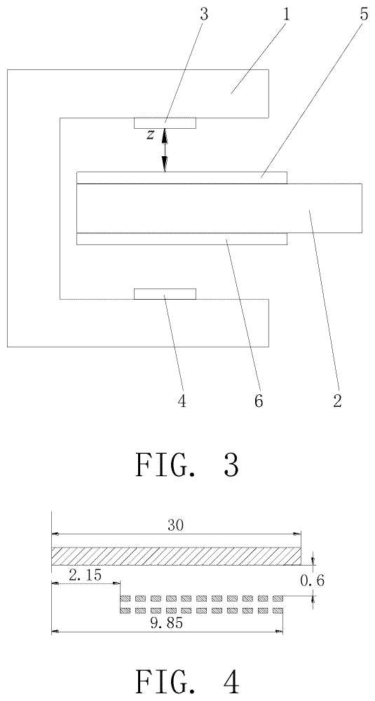

The present disclosure provides a non-contact three-dimensional (3D) displacement sensor, including a mechanical probe and a detection circuit. As shown in FIGS. 1-3, the mechanical probe includes a differential fixing block 1 and a cantilever 2, the differential fixing block 1 is U-shaped, and an end portion of the cantilever 2 is suspended within inner sides of the differential fixing block 1. In actual use, the differential fixing block 1 and the cantilever 2 are respectively fixedly connected to two portions of a mechanism that move relative to each other at a position to be measured, or the two relatively moving portions themselves may directly function as the differential fixing block 1 and the cantilever 2. Two differential coils are respectively fixedly disposed on two parallel inner side surfaces of the differential fixing block 1, and the two differential coils include a first differential coil 3 and a second differential coil 4. A first target conductor 5 is fixedly disposed on a top surface of the end portion of the cantilever 2 and is disposed directly below the first differential coil 3, and a second target conductor 6 is fixedly disposed on a bottom surface of the end portion of the cantilever 2 and is disposed directly above the second differential coil 4. Specifically, grooves are respectively defined on two parallel inner side surfaces of the differential fixing block 1, and the first differential coil 3 and the second differential coil 4, which have the same structure, are respectively symmetrically fixed and bonded to bottom surfaces of the grooves. A line connecting centers of the two differential coils is perpendicular to the two parallel inner side surfaces of the differential fixing block 1. A wiring groove is formed on one side of each of the grooves and on a side surface of the differential fixing block 1, for accommodating routing of connection wires of the first differential coil 3 and the second differential coil 4. The first differential coil 3 and the second differential coil 4 each includes a dual-layer stacked configuration with series connected windings arranged end to end, that is, two identical coils are connected in series to function as a single integrated coil, thereby increasing displacement sensitivity of both the first differential coil 3 and the second differential coil 4. In the embodiment, eddy current sensor (ECS) probe coils, namely the first differential coil 3 and the second differential coil 4 (i.e., eddy current coils), respectively have inner and outer radii of 2.15 mm and 9.85 mm. The first target conductor 5 and the second target conductor 6 have the same structure and are both made of rectangular metal plates. In the embodiment, the first target conductor 5 and the second target conductor 6 are made of pure aluminum plates each with a side length of 60 mm and a thickness of 0.1 mm. The first target conductor 5 and the second target conductor 6 are respectively symmetrically fixed and bonded to upper and lower surfaces of the cantilever 2, and are both parallel to the two parallel inner side surfaces of the differential fixing block 1.

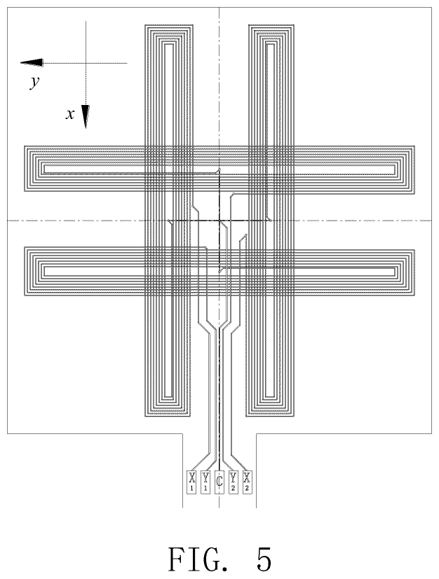

As shown in FIG. 5, a pair of first receiving coils Lₓ is fixedly disposed along a horizontal X-direction on a top surface of the first target conductor 5, and a pair of second receiving coils L_{y} is fixedly disposed along a horizontal Y-direction thereon. The first receiving coils Lₓ of each pair are arranged parallel to each other, the second receiving coils L_{y} of each pair are arranged parallel to each other, and the pair of the first receiving coils Lₓ and the pair of the second receiving coils L_{y} are arranged perpendicular to each other to form a grid pattern. In the embodiment, an innermost turn of each individual receiving coil among the pair of the first receiving coils Lₓ and the pair of the second receiving coils L_{y} has a long side of 38 mm and an innermost width of 0.8 mm. Each receiving coil among the pair of the first receiving coils Lₓ and the pair of the second receiving coils L_{y} has 20 turns, with both a line width and a line spacing being 75 μm. All four receiving coils of the pair of the first receiving coils Lₓ and the pair of the second receiving coils L_{y} have the same structure. In an the initial state, a Z-direction distance between the first differential coil 3 and the first target conductor 5 is equal to that between the second differential coil 4 and the second target conductor 6, which is set to 0.6 mm in the embodiment; a Y-direction distance between the pair of the first receiving coils Lₓ is equal to that between the pair of the second receiving coils L_{y}, which is set to 5.54 mm in the embodiment; and an intersection point of centerlines of the pair of the first receiving coils Lₓ and the pair of the second receiving coils L_{y} is located on a line connecting centers of the first differential coil 3 and the second differential coil 4. A spatial coordinate system is established by defining a symmetry axis of the pair of the first receiving coils Lₓ as an X-axis, a symmetry axis of the pair of the second receiving coils L_{y} as a Y-axis, and the line connecting the centers of the first differential coil 3 and the second differential coil 4 as a Z-axis, with an intersection point of the X-axis, the Y-axis, and the Z-axis serving as an origin.

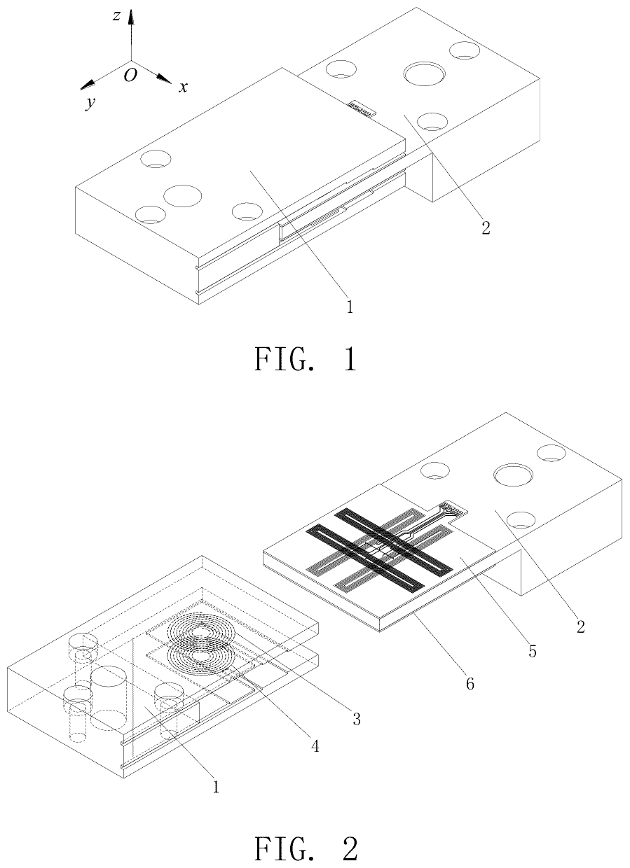

According to a structural configuration shown in FIGS. 1-2, a two-dimensional axisymmetric model is established and simulated using the COMSOL Multiphysics 6.2 software. The two-dimensional axisymmetric simulation greatly reduces computational load while maintaining nearly the same level of accuracy. As shown in FIG. 4, in accordance with an actual configuration, each of the first differential coil 3 and the second differential coil 4 adopts the dual-layer stacked configuration, with inner and outer diameters thereof respectively being 2.15 mm and 9.85 mm.

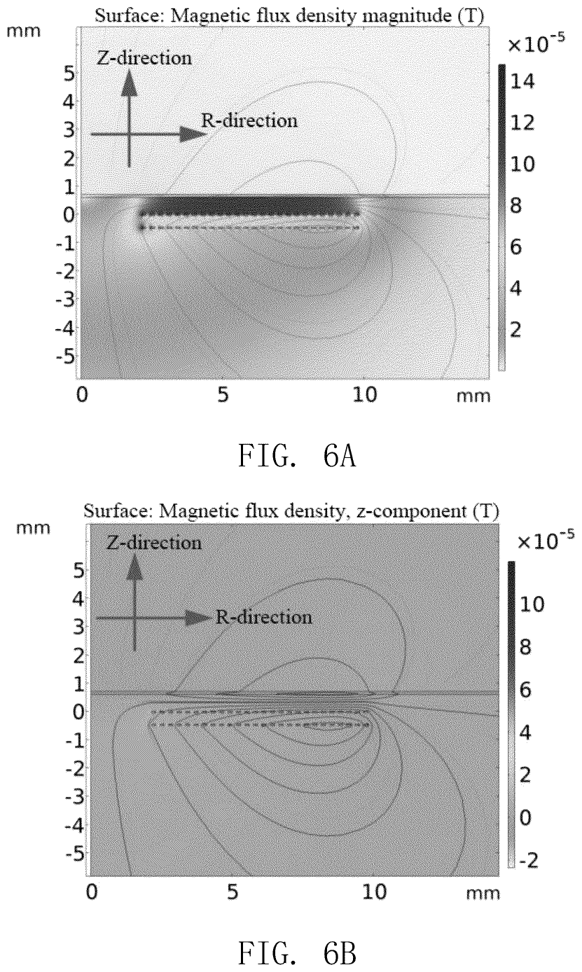

In the simulation, magnetic flux density distribution in a radial (R) direction at a surface of one target conductor, as well as other related parameters, was calculated, as shown in FIG. 6. magnetic flux density reaches its maximum value in A region between one differential coil and a corresponding target conductor. However, as indicated by a direction of contour lines in FIG. 6A, majority of magnetic flux is concentrated along the R direction. Since a magnetic flux component in a Z-direction is of greater interest, FIG. 6B illustrates magnetic flux density distribution in the Z-direction. It can be observed that magnetic flux density in the Z-direction is significantly smaller compared to that in the R direction.

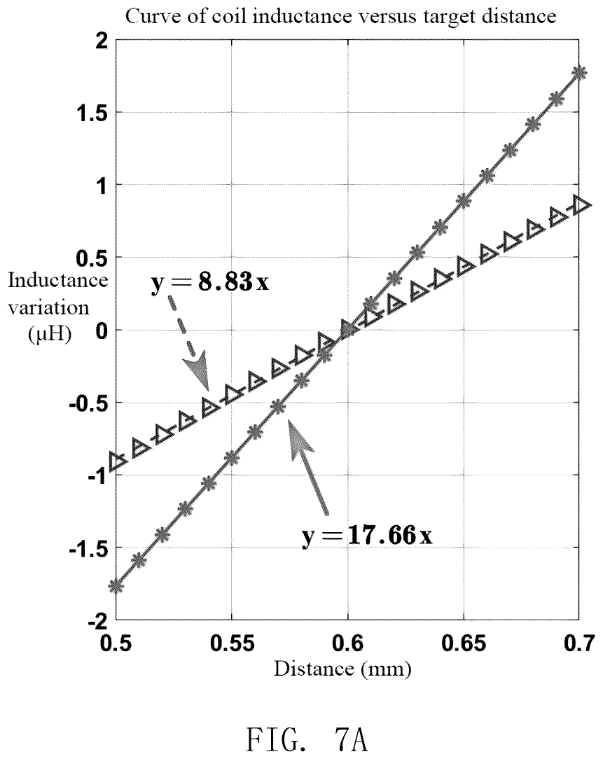

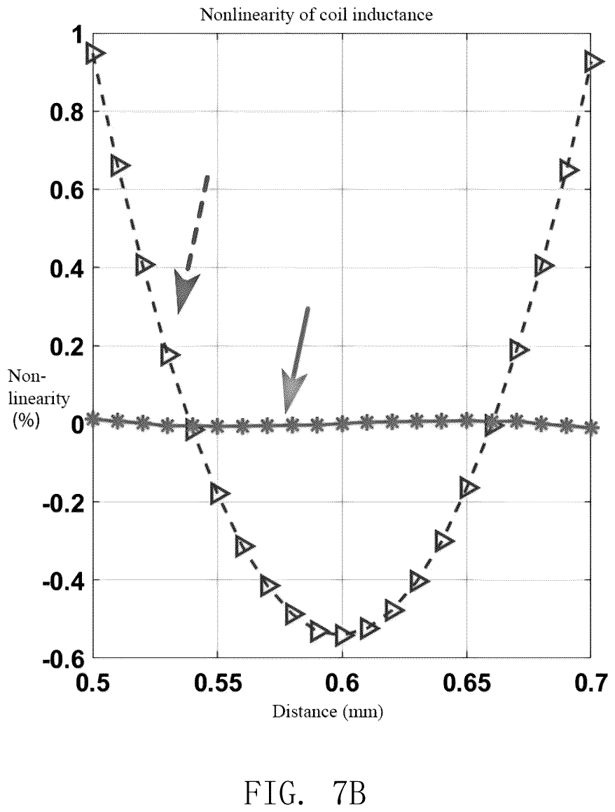

In general, a measurement range of a probe of an ECS maintains good linearity within a sub-millimeter scale. As shown in FIG. 7, simulations are performed for a single-ended ECS probe coil (i.e., consisting of only one eddy current coil and one target conductor) and a differential ECS coil (i.e., including two eddy current coils). Such simulations evaluate inductance variation and nonlinearity within a measurement range of 200 μm near 0.6 mm from a surface of the one target conductor.

As shown in FIG. 7A, output sensitivity of the differential ECS coil is 17.66 μH/mm, which is twice that of the single-ended ECS probe coil (8.83 μH/mm). As shown in FIG. 7B, nonlinearity of the differential ECS coil is +0.01%, which is much smaller than that of the single-ended ECS probe coil (±0.95%). Therefore, adopting a differential configuration for the probe of the ECS ensures higher sensitivity and superior linearity performance. Accordingly, the probe of the ECS shown in FIGS. 1-3 achieves displacement measurement in the Z-direction.

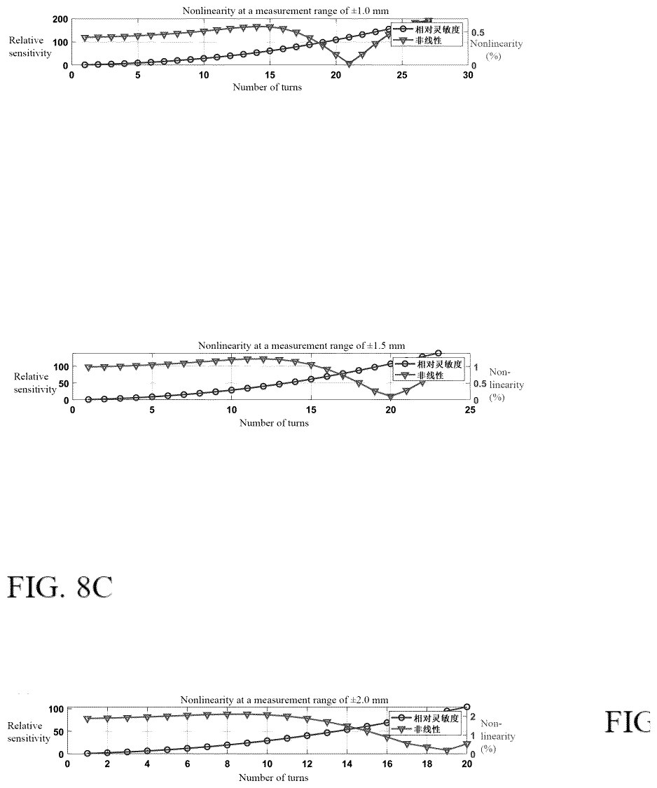

The number of turns of inductive receiving coils (the pair of the first receiving coils Lₓ and the pair of the second receiving coils L_{y}) is calculated and analyzed to determine its effect on sensitivity and nonlinearity of an inductive displacement sensor (IDS). As shown in FIGS. 8A-C, effects of the number of turns on sensitivity and nonlinearity are obtained for measurement ranges of ±1 mm, ±1.5 mm, and ±2 mm, respectively. Both a wire diameter and a spacing between adjacent turns are set to 3 mil (75 μm). In the figures, sensitivities corresponding to different numbers of turns are expressed relative to a sensitivity of a single inner-layer coil.

From the figures, it is observed that the larger the measurement range, the smaller the number of turns that is wound. This is because, regardless of displacement in an X-direction of a Y-direction, a long side of each receiving coil must not cross its parallel symmetry centerline. Therefore, to achieve a larger measurement range, the number of turns must be reduced, that is, the number of turns and the measurement range are mutually constrained. It is also evident that a larger number of turns results in higher sensitivity. Accordingly, a large measurement range and high sensitivity are mutually contradictory and cannot be simultaneously achieved. From the perspective of nonlinearity optimization, regardless of the measurement range setting, there always exists an optimal number of turns that minimizes nonlinearity. For example, as shown in FIG. 8B, when the measurement range is ±1.5 mm, the nonlinearity reaches as low as ±0.11% at 20 turns, and the corresponding sensitivity is 107 times that of an innermost single-layer coil.

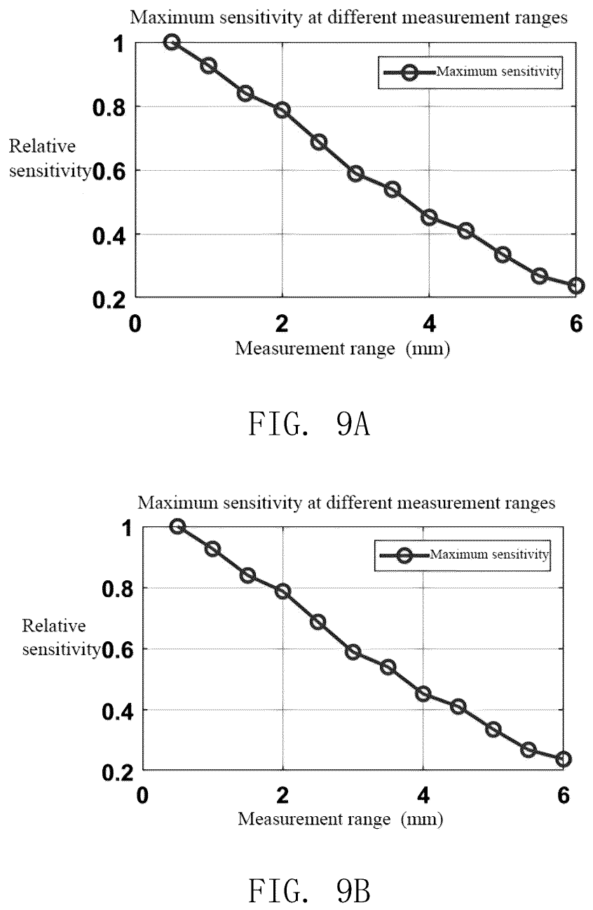

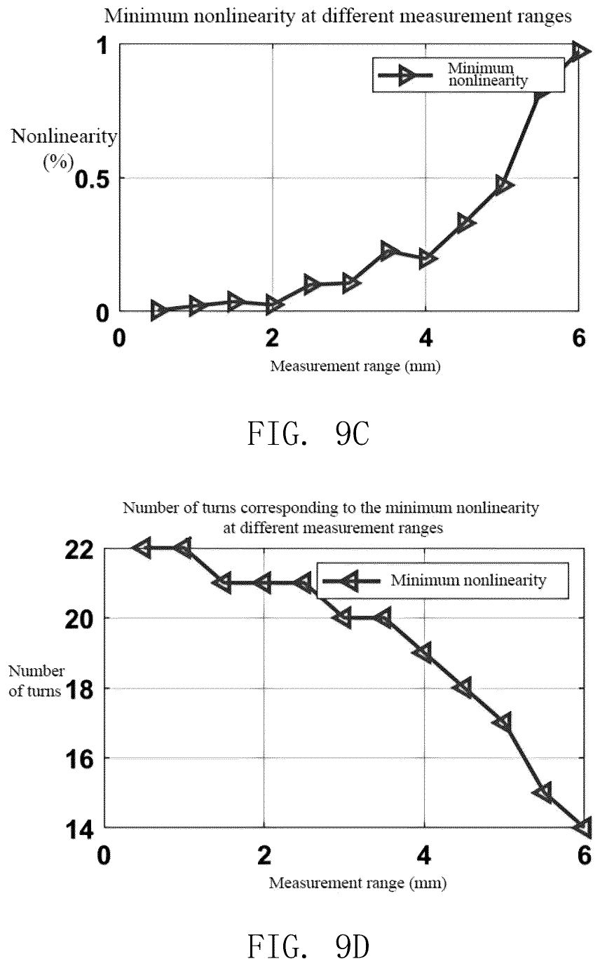

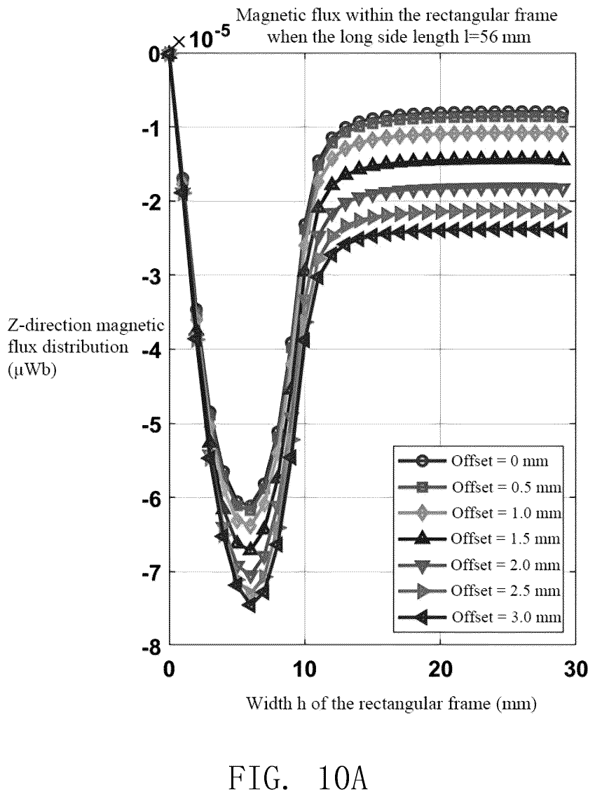

Taking the sensitivity, the nonlinearity, and the measurement range as optimization objectives, the maximum achievable sensitivity and minimum nonlinearity of the inductive receiving coils at different measurement ranges, as well as the corresponding number of turns for each case, were calculated, as shown in FIG. 9. As is seen from the FIG. 9, a larger measurement range leads to a lower maximum sensitivity, since a larger range implies fewer turns and therefore a smaller mutual inductance between the inductive receiving coils and the eddy current coils. Similarly, as the measurement range increases, the minimum nonlinearity also increases. However, for any given measurement range, the number of turns corresponding to the minimum nonlinearity does not necessarily coincide with that corresponding to the maximum sensitivity. Therefore, a trade-off between nonlinearity and sensitivity must be considered when designing the inductive receiving coils. In the embodiment, the number of turns of the inductive receiving coils is set to 20, which meets performance requirements.

Furthermore, optimization of decoupling performance in the X-direction and Y-direction is as follows.

In the above optimization analysis of maximum sensitivity and minimum nonlinearity, decoupling requirements in the X-direction and Y-direction are not considered, i.e., it is assumed that the inductive receiving coils move only along one direction (the X-direction or the Y-direction). In practice, since the inductive receiving coils of the IDS are allowed to move relative to the eddy current coils within a plane defined by the X-direction and the Y-direction, it is necessary to analyze factors affecting decoupling performance. Following analysis takes a single one of the pair of the first receiving coils Lₓ in the X-direction as an example to study effect of offsets in the Y-direction on coil outputs.

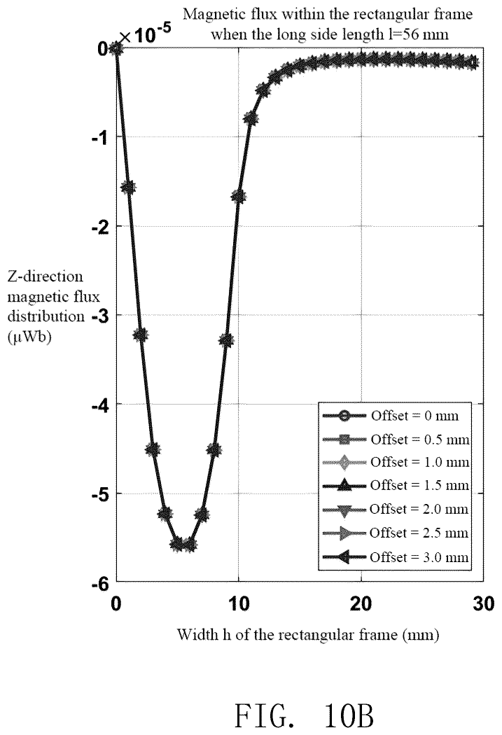

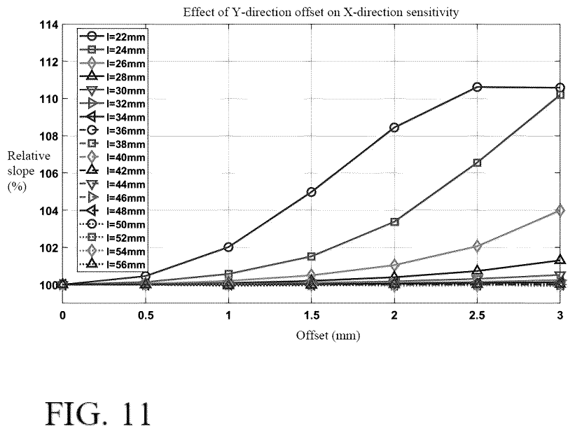

FIGS. 10A and 10B respectively show magnetic flux inside two types of a rectangular frame with long side lengths 1 of 22 mm and 56 mm under different offsets in the Y-direction. As shown in FIG. 10, when the long side length 1 is equal to 22 mm, internal magnetic flux is much more affected by the offsets compared to the case of the long side length 1 is equal to 56 mm. Therefore, a length of each of the inductive receiving coils should not be too small. To quantify effect of the long side length 1 and an offset Δy on displacement sensitivity of the inductive receiving coils, variation of the magnetic flux in the inductive receiving coils relative to the eddy current coils is calculated to quantitatively represent outputs of the inductive receiving coils. An effect of the offsets in the Y-direction on X-direction displacement sensitivity of the inductive receiving coils is shown in FIG. 11.

For the pair of the first receiving coils Lₓ, displacement thereof in a non-sensitive direction (the Y-direction) affects sensitivity thereof in a sensitive direction (the X-direction). However, this effect rapidly decreases as a coil dimension (the long side length 1) in the non-sensitive direction increases. When the long side length 1 in the non-sensitive direction is greater than or equal to 36 mm, a 1.5 mm offset causes less than a 0.02% variation in sensitivity, and a 3 mm offset causes less than a 0.07% variation. To ensure decoupling performance of the pair of the first receiving coils Lₓ in the X-direction and the Y-direction, an innermost layer length of each of the inductive receiving coils is equal to or greater than 36 mm. Therefore, in the embodiment, the innermost layer length of the inductive receiving coil is selected as 38 mm, which meets the performance requirements.

When the first differential coil 3 and the second differential coil 4 are in a state of being supplied with an excitation signal, and when relative displacement occurs between the differential fixing block 1 and the cantilever 2, a difference between output signals respectively at an output terminal of the first differential coil 3 and an output terminal of the second differential coil 4 is demodulated by a measurement circuit to output a Z-direction displacement output voltage Uz, the Z-direction displacement output voltage Uz quantitatively represents a relative displacement between the cantilever 2 and the differential fixing block 1 in the Z-direction. A difference between output signals respectively at output terminals of the two receiving coils of each pair is demodulated by the measurement circuit to respectively output an X-direction displacement output voltage Ux and a Y-direction displacement output voltage Uy, the X-direction displacement output voltage Ux quantitatively represents a relative displacement between the cantilever 2 and the differential fixing block 1 in the X-direction, the Y-direction displacement output voltage Uy quantitatively represents a relative displacement between the cantilever 2 and the differential fixing block 1 in the Y-direction.

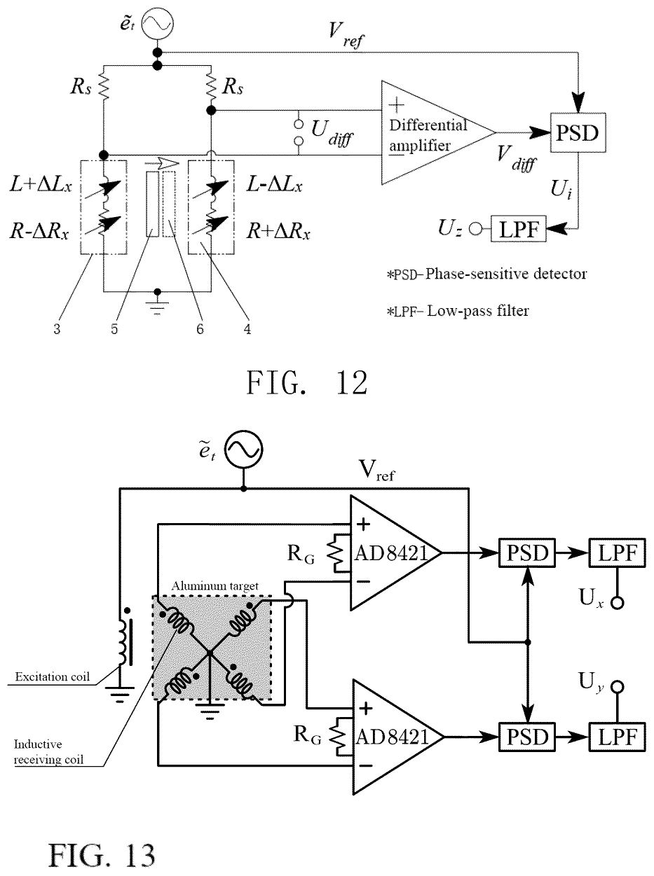

Specifically, as shown in FIGS. 12 and 13, the detection circuit includes an excitation power supply, a differential amplifier, an X-direction instrumentation amplifier, a Y-direction instrumentation amplifier, a Z-direction phase-sensitive detector, an X-direction phase-sensitive detector, and a Y-direction phase-sensitive detector. A first terminal of the first differential coil 3 and a first terminal of the second differential coil 4 are both grounded, a second terminal of the first differential coil 3 and a second terminal of the second differential coil 4 are respectively connected in series with first terminals of two matching resistors Rs, and second terminals of the two matching resistors Rs are connected to an output terminal of the excitation power supply. Two connection points between the two differential coils and the two matching resistors Rs are respectively connected to two signal input terminals of the differential amplifier, an output terminal of the differential amplifier and the output terminal of the excitation power supply are respectively connected to two input terminals of the Z-direction phase-sensitive detector, and the Z-direction phase-sensitive detector is configured to output the Z-direction displacement output voltage Uz.

First terminals of the pair of the first receiving coils Lₓ and first terminals of the pair of the second receiving coils L_{y} are grounded, and second terminals of the pair of the first receiving coils Lₓ and second terminals of the pair of the second receiving coils L_{y} are respectively connected to two input terminals of the X-direction instrumentation amplifier and two input terminals of the Y-direction instrumentation amplifier. An output terminal of the X-direction instrumentation amplifier, an output terminal of the Y-direction instrumentation amplifier, and the output terminal of the excitation power supply are respectively connected to two input terminals of the X-direction phase-sensitive detector and two input terminals of the Y-direction phase-sensitive detector, the X-direction phase-sensitive detector is configured to output the X-direction displacement output voltage Ux, and the Y-direction phase-sensitive detector is configured to output the Y-direction displacement output voltage Uy.

In some embodiments, an output terminal of each of the Z-direction phase-sensitive detector, the X-direction phase-sensitive detector, and the Y-direction phase-sensitive detector is connected to a low-pass filter (LPF).

As shown in FIG. 12, in a signal processing circuit of the ECS, the probe wound with a single eddy current coil is electrically equivalent to a series connection of a resistance R and an inductance L. In the circuit, a differential output voltage from the first differential coil 3 and the second differential coil 4 of an alternating current (AC) bridge is denoted as U_{diff}. For the first differential coil 3 and the second differential coil 4 of the probe of the differential ECS, when displacement variation is very small (sub-millimeter range), within a Z-direction detection stroke, a resistance variation for both the first differential coil 3 and the second differential coil 4 is ΔR, and an inductance variation for both the first differential coil 3 and the second differential coil 4 is ΔL, but a variation direction of the first differential coil 3 and a variation direction of the second differential coil 4 are opposite, such that a differential output voltage of U_{diff} from the first differential coil 3 and the second differential coil 4 of the AC bridge is expressed as follows:

$${U}_{diff} = \frac{2 \tilde{e} {R}_{s} ( - Δ R + j ω Δ L )}{( j ω ( L + Δ L ) + R + Δ R + {R}_{s} ) ( j ω ( L - Δ L ) + R - Δ R + {R}_{s} )} ; \qquad ( 1 )$$

the Z-direction displacement output voltage Uz is expressed as follows:

$${U}_{z} = 2 {K}_{1} {K}_{2} Z ωΔ LE ; \qquad ( 2 )$$

$$Z \approx \frac{{R}_{s}}{\vert {( R + {R}_{s} )}^{2} - {ω}^{2} {L}^{2} + 2 j ω L ( R + {R}_{s} ) \vert} ; \qquad ( 3 )$$

specifically, E is an amplitude of an excitation voltage \tilde{e}, ω is an angular frequency of the excitation voltage, K₁ is a signal gain of the differential amplifier, K₂ is a signal gain of the Z-direction phase-sensitive detector, Rs is a resistance value of each of the two matching resistors, R is an equivalent resistance of each of the first differential coil 3 and the second differential coil 4, and L is an equivalent inductance of each of the first differential coil 3 and the second differential coil 4.

As is seen from expression (2), the Z-direction displacement output voltage Uz of the ECS is proportional to the inductance variation ΔL of the coil, which is consistent with the preceding analysis.

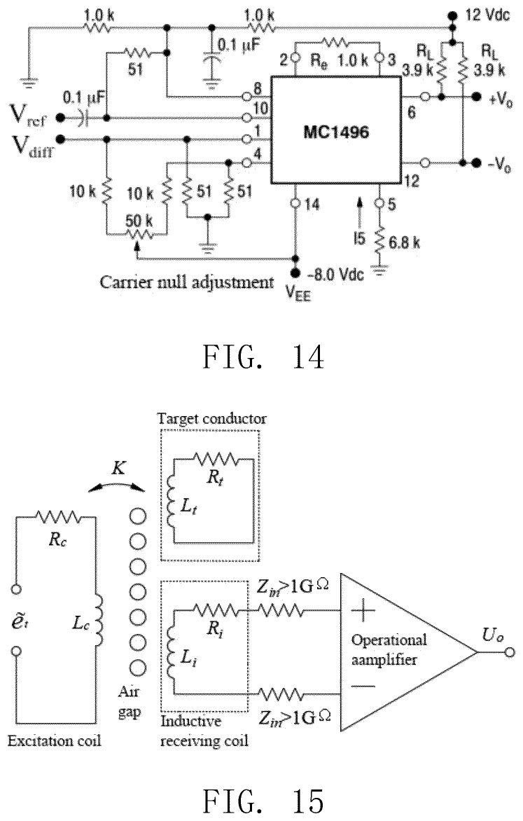

In the embodiment, a phase-sensitive detector (PSD) shown in FIG. 12 is designed based on an MC1496 balanced modulator-demodulator chip, and a detailed circuit diagram is shown in FIG. 14. The MC1496 balanced modulator-demodulator chip operates in a nonlinear region and functions as a switching multiplier to demodulate weak signals.

Signal demodulation of the IDS is as follows.

As shown in FIG. 15, an equivalent model of the non-contact 3D displacement sensor is presented. The inductive receiving coils includes four coils in total, which are grouped into two pairs. For clarity, only one coil is illustrated in the equivalent model. The inductive receiving coils and the excitation coils (i.e., the first differential coil 3 and the second differential coil 4, also referred to as the eddy current coils) are operated based on an electromagnetic induction effect. To ensure that newly added inductive receiving coils do not affect performance of the ECS, an impedance of each of the inductive receiving coils is kept as high as possible (greater than 1 GΩ). To achieve this, an input impedance Zᵢₙ of an operational amplifier, which is connected in series with non-inverting and inverting inputs, is designed to exceed 1 GΩ. When a loop impedance Zᵢ of the inductive receiving coils is higher than 1 GΩ, a current inside the inductive receiving coils is neglected compared with the eddy current induced in one target conductor. In this case, the inductive receiving coils behave as an open circuit, which does not generate a magnetic field that could affect the excitation coils, and also does not increase load of the excitation coils. Therefore, the performance of the ECS remains unaffected by addition of the inductive receiving coils.

As shown in FIG. 13, in order to meet a requirement of high impedance on a side of each of the inductive receiving coils, both terminals of each of the inductive receiving coils are directly connected to a corresponding instrumentation amplifier. In the embodiment, the X-direction instrumentation amplifier, the Y-direction instrumentation amplifier, the Z-direction phase-sensitive detector are model AD8421, a high-performance amplifier designed and manufactured by Analog Devices, Inc. The model AD8421 provides a differential and common-mode input impedance as high as 30 GΩ, thereby ensuring that the addition of the IDS does not affect original performance of the ECS.

As shown in FIG. 13, the pair of first receiving coils Lₓ and the pair of the second receiving coils L_{y} respectively have mutual inductances of Mₓ and M_{y} with the first differential coil 3; when an excitation current with a frequency of ω and an amplitude of I is applied to the first differential coil 3 and the second differential coil 4, an induced voltage amplitude of Vₓ across the pair of the first receiving coils Lₓ and an induced voltage amplitude of V_{y} across the pair of the second receiving coils L_{y} are expressed as follows:

$$\{ \begin{matrix}{V}_{x} = ω {M}_{x} I \\ {V}_{y} = ω {M}_{y} I\end{matrix} ; \qquad ( 4 )$$

the X-direction displacement output voltage Ux and the Y-direction displacement output voltage Uy are expressed as follows:

$$\{ \begin{matrix}{U}_{x} = {K}_{3} {K}_{4} ω {M}_{x} I \\ {U}_{y} = {K}_{3} {K}_{4} ω {M}_{y} I\end{matrix} ; \qquad ( 5 )$$

specifically, K3 is a signal gain of each of the X-direction instrumentation amplifier and the Y-direction instrumentation amplifier, and K4 is a signal gain of each of the X-direction phase-sensitive detector and the Y-direction phase-sensitive detector.

It can be seen that the X-direction displacement output voltage Ux is affected by both the mutual inductance Mx and an amplitude I of the excitation current, while the Y-direction displacement output voltage Uy is affected by both the mutual inductance My and the amplitude I of the excitation current. When geometric dimensions, number of turns, and other parameters of the excitation coils and the inductive receiving coils are determined, and when the excitation current is constant and a distance between the excitation coils and the inductive receiving coils in the Z-direction is fixed, the mutual inductances Mx and My are determined only by relative positions between the excitation coils and the inductive receiving coils in a horizontal direction. Therefore, by measuring the X-direction displacement output voltage Ux and the Y-direction displacement output voltage Uy, two-dimensional displacements of the inductive receiving coils in the X-direction and the Y-direction within a horizontal plane is obtained. The number of turns, the geometric dimensions, and other parameters of the inductive receiving coils all affect their mutual inductances with the excitation coils. By optimizing these parameters of the inductive receiving coils, sensitivity of the IDS is improved and nonlinearity of the IDS is reduced.

Mutual inductances Mx and My are affected not only by relative positions of the inductive receiving coils and the excitation coils in the X-direction and the Y-direction, but also by their relative positions in the Z-direction. In other words, displacement along the Z-direction also causes variation of change the outputs of the IDS in the X-direction and the Y-direction. Consequently, the outputs of the IDS in the X-direction and the Y-direction are not decoupled from Z-direction displacement. The following provides a simulation analysis of a specific effect of the Z-direction displacement on the outputs of the IDS in the X-direction and the Y-direction and presents a solution to eliminate that effect.

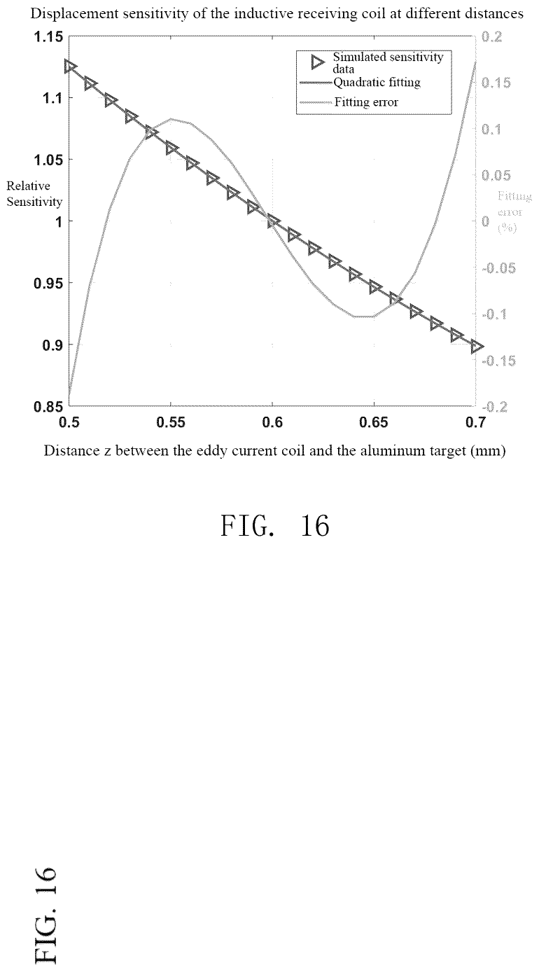

A distance between the first target conductor 5 and the first differential coil 3 in the Z-direction is denoted as z. Displacement sensitivities of the inductive receiving coils of the IDS in the X-direction and the Y-direction are simulated for different values of z. A simulation result is shown in FIG. 16. For ease of comparison, relative displacement sensitivity values at different distances in the figure are presented as a ratio of a sensitivity at each distance to a sensitivity at the distance z of 0.6 mm.

As shown in FIG. 16, when inner and outer radii of each of the excitation coils are respectively 2.15 mm and 9.85 mm, the distance z between each of the excitation coils and a corresponding target conductor has a significant effect on the displacement sensitivities of the inductive receiving coils of the IDS in the X-direction and the Y-direction. When the cantilever 2 of the ECS is located at a symmetric equilibrium position in a middle of the differential fixing block 1, i.e., when the distance z is equal to 0.6 mm, the displacement sensitivities of the inductive receiving coils of the IDS in the X-direction and the Y-direction are normalized to 1. When the distance z is equal to 0.5 mm, the displacement sensitivities of the inductive receiving coils of the IDS in the X-direction and the Y-direction increase to 1.13, and when the distance z is equal to 0.7 mm, the displacement sensitivities of the inductive receiving coils of the IDS in the X-direction and the Y-direction decrease to 0.90. The displacement sensitivities of the inductive receiving coils of the IDS in the X-direction and the Y-direction is well fitted by a second-order polynomial, with a maximum fitting error of =0.19% of a full scale.

To reduce the effect of the Z-direction displacement on the sensitivities of the IDS in the X-direction and the Y-direction, the present disclosure proposes that the displacement in the −Z-direction recorded by the ECS is used to correct the outputs of the IDS in the X-direction and the Y-direction, thereby achieving decoupling among three axes. In this way, the ECS for measuring the Z-direction displacement, and the IDS for measuring the X-direction displacement and the Y-direction displacement, are combined to create the non-contact 3D displacement sensor of the present disclosure.

Performance test is as follows.

### (1) ECS Sensitivity Measurement

Performance of the ECS in the Z-direction was measured using a high-precision piezoelectric displacement stage (Model: N-565) manufactured by Physik Instrumente (PI), Germany. As shown in FIG. 17, a piezoelectric displacement stage 21 is fixed on an air-bearing platform 22. The differential fixing block 1 with the two differential coils is disposed on a first one of test fixtures 24 at a top portion of the second base 25 and secured using a first one of clamping blocks 23. The cantilever 2 with the inductive receiving coils is on a second one of the test fixtures 24 at a top portion of the piezoelectric displacement stage 21 and secured using a second one of the clamping blocks 23, such that the cantilever 2 is disposed at an equilibrium position in the differential fixing block 1. Threaded rods are respectively horizontally arranged and rotatably connected to sides of the test fixtures 24, and a knob is fixed to an end of each of the threaded rods. Through holes are respectively defined on both the differential fixing block 1 and the cantilever 2, through which the threaded rods respectively passe. The clamping blocks 23 are respectively threadedly connected to outer sides of the threaded rods, and an outer side edge of each of the clamping blocks 23 is fixedly connected to a side surface of at least one of the differential fixing block 1 and the cantilever 2 via screws. By rotating each knob, a corresponding one of the threaded rods is driven to rotate, thereby adjusting a horizontal distance between each of the clamping blocks 23 and a corresponding one of the test fixtures 24 through threaded engagement, thus respectively fixing the differential fixing block 1 and the cantilever 2 on the test fixtures 24.

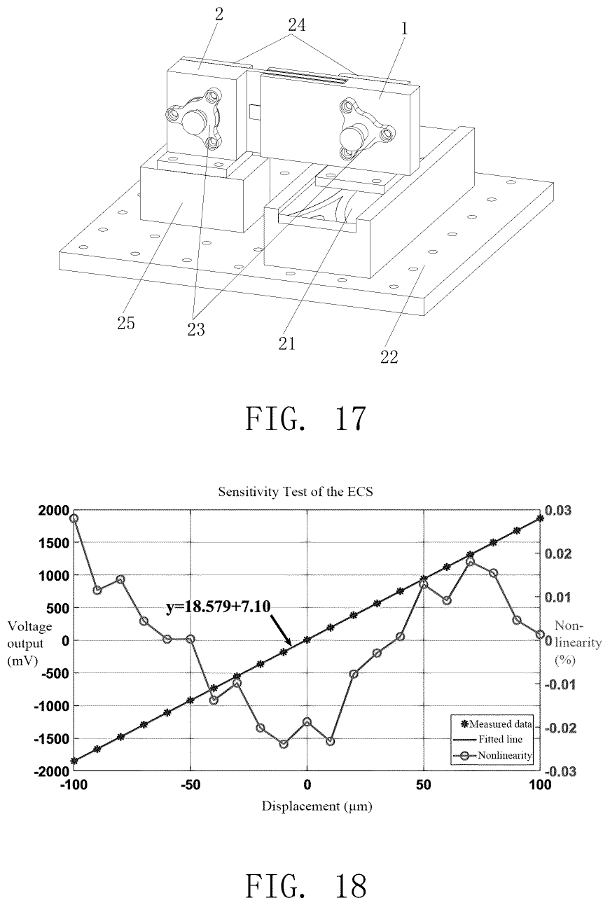

As shown in FIG. 18, the piezoelectric displacement stage 21 is controlled to move step by step within a measurement range of 200 μm, with a step interval of 10 μm, completing a total of 20 steps across the full range. Output data of the ECS of the non-contact 3D displacement sensor are recorded and processed, and processed results are shown in FIG. 18. As shown in FIG. 18, Z-direction displacement sensitivity of the non-contact 3D displacement sensor is 18.579 mV/μm, and maximum nonlinearity over the full scale is ±0.028%, which is slightly higher than a simulation result shown in FIGS. 7A-7B. A position corresponding to 0 μm on a horizontal axis in FIG. 18 represents a symmetrical position of the ECS, where the distance z is equal 0.6 mm.

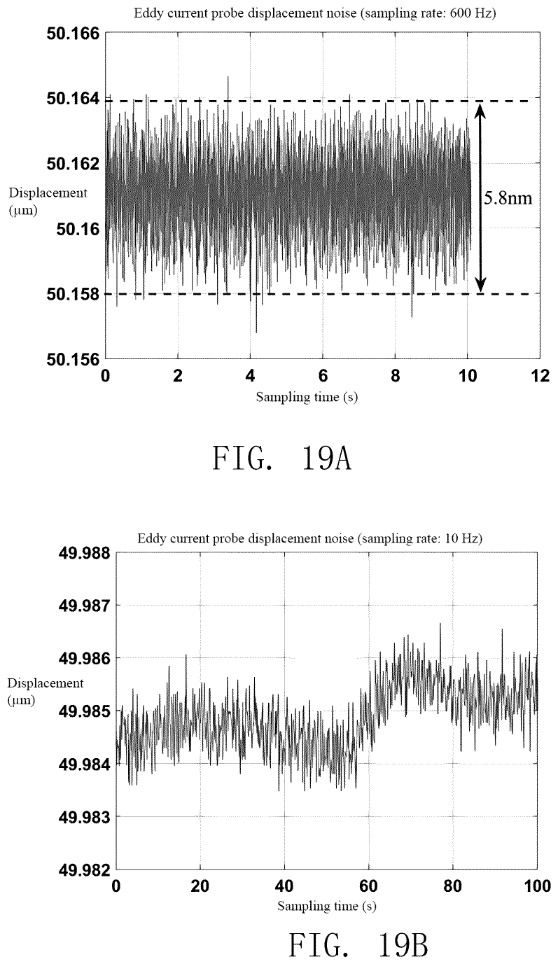

In addition, when the ECS is in a stable state, noise at a Z-direction displacement of 50 micrometers is recorded, as shown in FIG. 19A. FIG. 19A shows that when a sampling rate is 600 Hz, peak-to-peak noise in the Z-direction is 5.8 nm. FIG. 19B shows that when the sampling rate is 10 Hz, the peak-to-peak noise is 2 nm. At a confidence probability of 99.9%, a peak-to-peak value of a noise signal is approximately 6.6 times its root mean square (RMS) value. Therefore, a resolution of the ECS in the Z-direction is 0.88 nm at the sampling rate of 600 Hz, and a quasi-static resolution of the ECS within a frequency range of 0.1-10 Hz is 0.30 nm.

### (2) Performance Test of the IDS

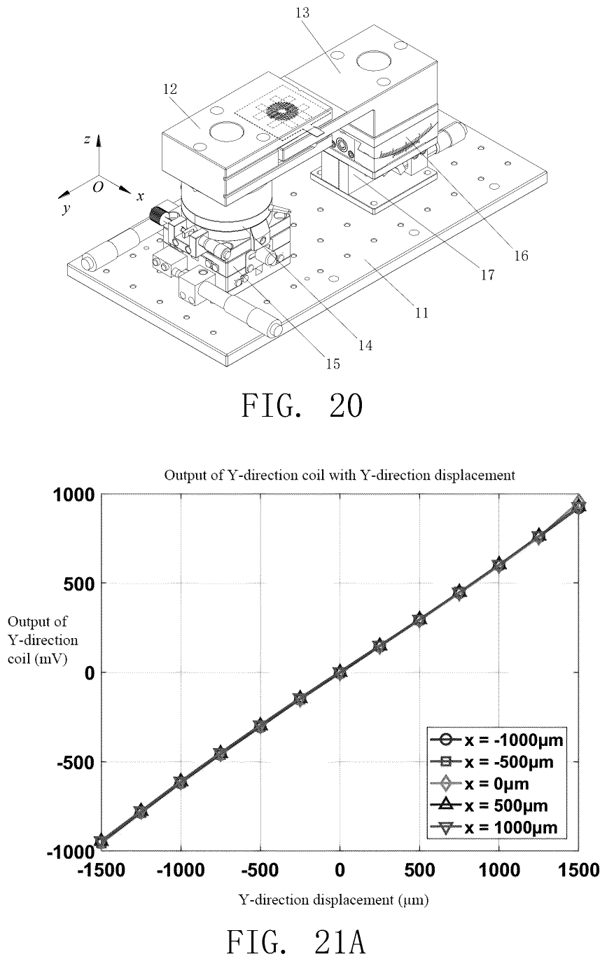

As shown in FIG. 20, a performance testing system for the IDS is provided. The excitation coils are fixedly attached to a lower surface of a top plate of a first cantilever beam 12, and corresponding target conductors with the inductive receiving coils are fixedly attached to an upper surface of a top plate of the second cantilever beam 13. A Z-axis rotary stage 14 and an XY-direction displacement stage 15 are sequentially stacked beneath the first cantilever beam 12, while an X-axis rotary stage 16 and a Z-direction displacement stage 17 are sequentially stacked beneath the second cantilever beam 13. The XY-direction displacement stage 15 and the Z-direction displacement stage 17 are fixedly connected to opposite sides of a top surface of a first base 11. The Z-axis rotary stage 14 is configured to adjust rotation of the first cantilever beam 12 such that two movement directions of the XY-direction displacement stage 15 are respectively parallel to two induction directions of the inductive receiving coils. The XY-direction displacement stage 15 enables relative displacement between the excitation coils and the inductive receiving coils in the plane defined by the X-direction and the Y-direction. The X-axis rotary stage 16 adjusts a planar position of the inductive receiving coils so that a plane where the inductive receiving coils are positioned is parallel to that of the excitation coils. The Z-direction displacement stage 17 is configured to adjust a vertical distance between the inductive receiving coils and the excitation coils, which is initially set to 0.6 mm in this experiment.

### (3) Decoupling Performance Test of the IDS

An inductive receiving coil with 15 turns is tested. The inductive receiving coil remains fixed in position, with its X-direction position kept constant, while an excitation coil is moved along the Y-direction within a range of ±1.5 mm around the equilibrium position, with a step size of 250 μm. Output signals of the inductive receiving coil are recorded during movement of the excitation coil. A total of five groups of tests are conducted, with the X-direction relative displacement between the excitation coil and the conductive receiving coil respectively set to −1000 μm, −500 μm, 0 μm, 500 μm, and 1000 μm.

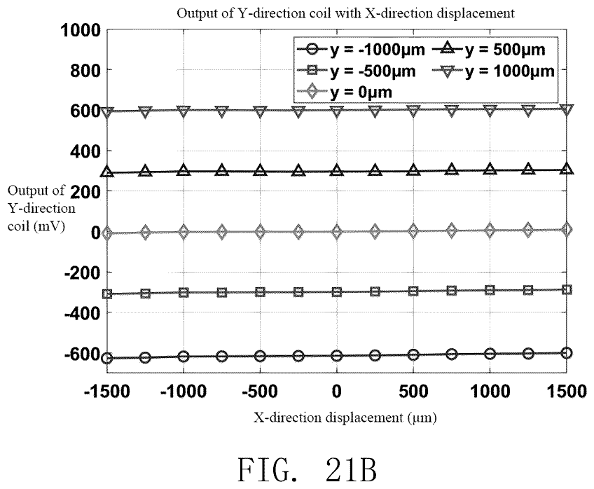

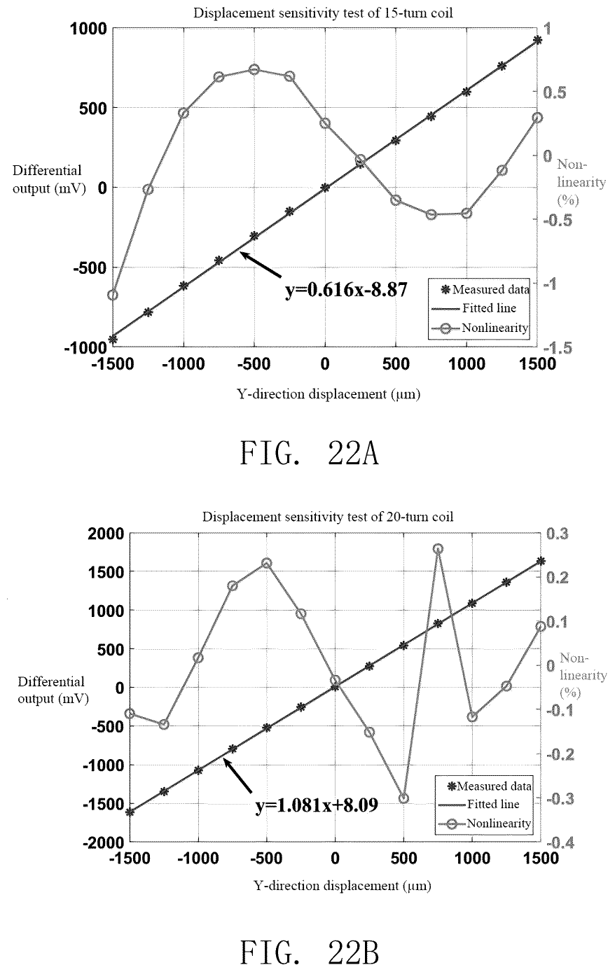

A sensitivity test result of output of the inductive receiving coil in the Y-direction under five different X-direction displacements are shown in FIG. 21A. The sensitivity test result indicates that the output of the inductive receiving coil in the Y-direction is proportional to the Y-direction displacement, exhibiting good linearity. Output curves corresponding to the different X-direction displacements almost overlap, which demonstrates that the output of the inductive receiving coil in the Y-direction of the IDS is nearly unaffected by variations in the X-direction displacement.

The inductive receiving coil remains fixed, with its position in the Y-direction kept constant. The excitation coil is moved in the X-direction within a range of ±1.5 mm around the equilibrium position, with a step size of 250 μm, and the output of the inductive receiving coil is recorded. A total of five groups of tests are conducted, with the Y-direction relative displacement between the excitation coil and the conductive receiving coil respectively set to set to −1000 μm, −500 μm, 0 μm, 500 μm, and 1000 μm.

A test result of output of the inductive receiving coil in the Y-direction with variations in the X-direction displacement is shown in FIG. 21B. As is seen, the output of the output of the inductive receiving coil in the Y-direction is almost only related to the Y-direction displacement. When the Y-direction position is fixed and the X-direction displacement varies, the output of the inductive receiving coil in the Y-direction remains nearly a straight line parallel to the X-axis, further confirming that the output of the inductive receiving coil in the Y-direction is hardly affected by the variations in the X-direction displacement. In summary, the IDS exhibits excellent decoupling performance, consistent with the simulation result.

### (4) Sensitivity and Nonlinearity Tests of the IDS

According to A simulation result of nonlinearity and sensitivity shown in FIG. 8B, when the measurement range is ±1.5 mm and the number of turns is 15, the minimum nonlinearity reaches ±1.06%. When the number of turns is 20, the nonlinearity is ±0.11%. A displacement sensitivity of the inductive receiving coil with 20 turns is 1.751 times that of the inductive receiving coil with 15 turns.

A measured nonlinearity of the inductive receiving coil with 15 turns is ±1.1%, which is consistent with the simulation result. A measured nonlinearity of the inductive receiving coil with 20 turns is ±0.3%, which is larger than the simulated result. This deviation is mainly attributed to displacement operation errors introduced by manually adjusting a micrometer head. However, the +0.3% nonlinearity is still significantly better than the +1.1% of the inductive receiving coil with 15 turns, and an overall trend of the measured nonlinearity agrees well with the simulation. An experimentally obtained slope of a fitted linear displacement output curve for the inductive receiving coil with 15 turns is 0.616 mV/μm, which represents the displacement sensitivity of the inductive receiving coil with 15 turns. The displacement sensitivity of the inductive receiving coil with 20 turns is 1.081 mV/μm, which is 1.755 times that of the inductive receiving coil with 15 turns, almost identical to the simulation result. These findings verify effectiveness of optimization measures proposed in the present disclosure.

### (5) Resolution Test of the IDS

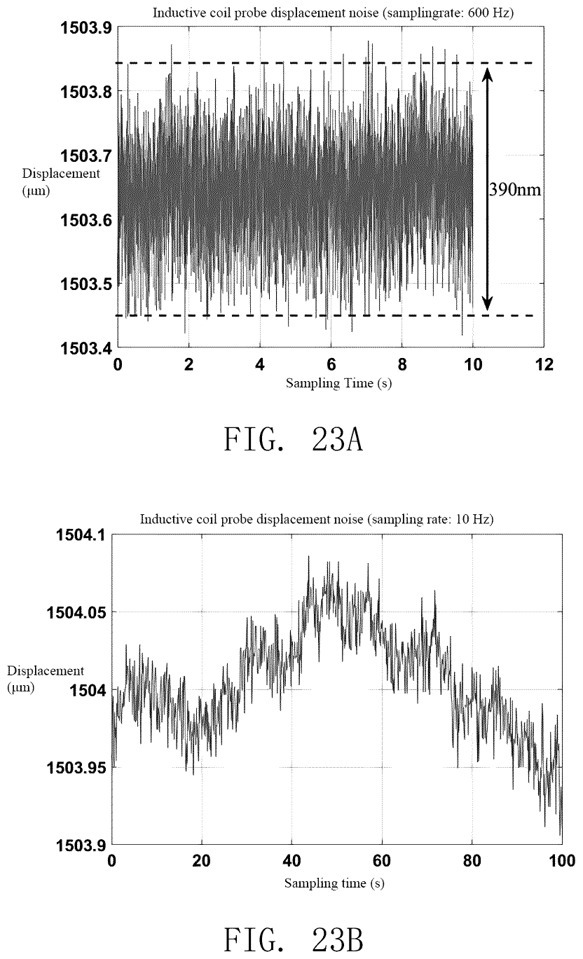

To analyze noise characteristics of the IDS, output displacement noise of the IDS is measured at a maximum displacement of 1.5 mm when the IDS in a stable state. As shown in FIG. 23, peak-to-peak noise is 390 nm at the sampling rate of 600 Hz, and 60 nm at a sampling rate of 10 Hz. At a 99.9% confidence probability, the peak-to-peak value of the noise signal is approximately 6.6 times its RMS value. Therefore, a resolution of the IDS is 60 nm at the sampling rate of 600 Hz, and a quasi-static resolution of the IDS in the frequency range of 0.1-10 Hz is 9 nm.

The non-contact 3D displacement sensor of the present disclosure achieves a quasi-static resolution of 9 nm in the X-direction and the Y-direction, and a resolution of 60 nm at a sampling rate of 600 Hz. The non-contact 3D displacement sensor also provides a large measurement range of 3 mm and a maximum nonlinearity of ±0.3% over the full range. In the Z-direction, the non-contact 3D displacement sensor achieves a sub-nanometer quasi-static resolution of 0.3 nm, and a resolution of 0.88 nm at the sampling rate of 600 Hz, with a maximum nonlinearity of ±0.028% within a full measurement range of 200 μm. By using a Z-direction displacement measurement to compensate for X-direction displacement sensitivity and Y-direction displacement sensitivity, the outputs of IDS in the X-direction and the Y-direction are decoupled from the Z-direction displacement. Since the outputs of IDS in the X-direction and the Y-direction are inherently decoupled from each other, the non-contact 3D displacement sensor of the present disclosure achieves full decoupling in all three directions, while exhibiting excellent performance in terms of linearity, measurement range, and sensitivity.

Technical features described in the foregoing embodiments of the present disclosure may be combined in any suitable manner. For the sake of brevity, all possible combinations of the technical features in the foregoing embodiments are not exhaustively described; however, as long as such combinations do not result in any contradiction and shall be deemed to fall within the protection scope of the present disclosure.

The foregoing description is merely illustrative of the embodiments of the present disclosure and should not be construed as limiting the protection scope of the present disclosure. Any equivalent structural or procedural modifications made based on contents of the specification and the accompanying drawings, or any applications thereof directly or indirectly applied to other related technical fields, shall fall within the protection scope of the present disclosure.

What is claimed is:

1. A non-contact three-dimensional (3D) displacement sensor, comprising:
a mechanical probe; and
a detection circuit;
wherein the mechanical probe comprises a differential fixing block and a cantilever, the differential fixing block is U-shaped, and an end portion of the cantilever is suspended within inner sides of the differential fixing block;
wherein two differential coils are respectively fixedly disposed on two parallel inner side surfaces of the differential fixing block, and the two differential coils comprise a first differential coil and a second differential coil;
wherein a first target conductor is fixedly disposed on a top surface of the end portion of the cantilever and is disposed directly below the first differential coil, and a second target conductor is fixedly disposed on a bottom surface of the end portion of the cantilever and is disposed directly above the second differential coil;
wherein a pair of first receiving coils is fixedly disposed along a horizontal X-direction on at least one of a top surface of the first target conductor and a bottom surface of the second target conductor, and a pair of second receiving coils is fixedly disposed along a horizontal Y-direction thereon;
wherein the first receiving coils of each pair are arranged parallel to each other, the second receiving coils of each pair are arranged parallel to each other, and the pair of the first receiving coils and the pair of the second receiving coils are arranged perpendicular to each other to form a grid pattern;
wherein when the first differential coil and the second differential coil are in a state of being supplied with an excitation signal, and when relative displacement occurs between the differential fixing block and the cantilever, a difference between output signals respectively at an output terminal of the first differential coil and an output terminal of the second differential coil is demodulated by a measurement circuit to output a Z-direction displacement output voltage, the Z-direction displacement output voltage quantitatively represents a relative displacement between the cantilever and the differential fixing block in a Z-direction, and the Z-direction is perpendicular to the two parallel inner side surfaces of the differential fixing block;
wherein a difference between output signals respectively at output terminals of the two receiving coils of each pair is demodulated by the measurement circuit to respectively output an X-direction displacement output voltage and a Y-direction displacement output voltage, the X-direction displacement output voltage quantitatively represents a relative displacement between the cantilever and the differential fixing block in an X-direction, the Y-direction displacement output voltage quantitatively represents a relative displacement between the cantilever and the differential fixing block in a Y-direction, a plane defined by the X-direction and Y-direction is parallel to the two parallel inner side surfaces of the differential fixing block.

2. The non-contact 3D displacement sensor according to claim 1, wherein the first differential coil and the second differential coil have the same structure, each comprising a dual-layer stacked configuration with series connected windings arranged end to end.

3. The non-contact 3D displacement sensor according to claim 1, wherein the detection circuit comprises an excitation power supply, a differential amplifier, an X-direction instrumentation amplifier, a Y-direction instrumentation amplifier, a Z-direction phase-sensitive detector, an X-direction phase-sensitive detector, and a Y-direction phase-sensitive detector;
a first terminal of the first differential coil and a first terminal of the second differential coil are both grounded, a second terminal of the first differential coil and a second terminal of the second differential coil are respectively connected in series with first terminals of two matching resistors, and second terminals of the two matching resistors are connected to an output terminal of the excitation power supply;
two connection points between the two differential coils and the two matching resistors are respectively connected to two signal input terminals of the differential amplifier, an output terminal of the differential amplifier and the output terminal of the excitation power supply are respectively connected to two input terminals of the Z-direction phase-sensitive detector, and the Z-direction phase-sensitive detector is configured to output the Z-direction displacement output voltage;
first terminals of the pair of the first receiving coils and first terminals of the pair of the second receiving coils are grounded, and second terminals of the pair of the first receiving coils and second terminals of the pair of the second receiving coils are respectively connected to two input terminals of the X-direction instrumentation amplifier and two input terminals of the Y-direction instrumentation amplifier;
an output terminal of the X-direction instrumentation amplifier, an output terminal of the Y-direction instrumentation amplifier, and the output terminal of the excitation power supply are respectively connected to two input terminals of the X-direction phase-sensitive detector and two input terminals of the Y-direction phase-sensitive detector, the X-direction phase-sensitive detector is configured to output the X-direction displacement output voltage, and the Y-direction phase-sensitive detector is configured to output the Y-direction displacement output voltage.

4. The non-contact 3D displacement sensor according to claim 3, wherein an output terminal of each of the Z-direction phase-sensitive detector, the X-direction phase-sensitive detector, and the Y-direction phase-sensitive detector is connected to a low-pass filter.

5. The non-contact 3D displacement sensor according to claim 3, wherein within a Z-direction detection stroke, a resistance variation for both the first differential coil and the second differential coil is ΔR, and an inductance variation for both the first differential coil and the second differential coil is ΔL, but a variation direction of the first differential coil and a variation direction of the second differential coil are opposite, such that a differential output voltage of U_{diff} from the first differential coil and the second differential coil of an alternating current (AC) bridge is expressed as follows:
$${U}_{diff} = \frac{2 \tilde{e} {R}_{s} ( - Δ R + j ω Δ L )}{( j ω ( L + Δ L ) + R + Δ R + {R}_{s} ) ( j ω ( L - Δ L ) + R - Δ R + {R}_{s} )} ; \qquad ( 1 )$$
the Z-direction displacement output voltage is expressed as follows:
$${U}_{z} = 2 {K}_{1} {K}_{2} Z ωΔ LE ; \qquad ( 2 )$$
$$Z \approx \frac{{R}_{s}}{\vert {( R + {R}_{s} )}^{2} - {ω}^{2} {L}^{2} + 2 j ω L ( R + {R}_{s} ) \vert} ; \qquad ( 3 )$$
wherein E is an amplitude of an excitation voltage, ω is an angular frequency of the excitation voltage, K₁ is a signal gain of the differential amplifier, K₂ is a signal gain of the Z-direction phase-sensitive detector, Rs is a resistance value of each of the two matching resistors, R is an equivalent resistance of each of the first differential coil and the second differential coil, and L is an equivalent inductance of each of the first differential coil and the second differential coil.

6. The non-contact 3D displacement sensor according to claim 3, wherein the pair of first receiving coils and the pair of the second receiving coils respectively have mutual inductances of Mₓ and M_{y} with the first differential coil or the second differential coil;
when an excitation current with a frequency of ω and an amplitude of I is applied to the first differential coil and the second differential coil, an induced voltage amplitude of Vₓ across the pair of the first receiving coils and an induced voltage amplitude of V_{y} across the pair of the second receiving coils are expressed as follows:
$$\{ \begin{matrix}{V}_{x} = ω {M}_{x} I \\ {V}_{y} = ω {M}_{y} I\end{matrix} ; \qquad ( 4 )$$
the X-direction displacement output voltage and the Y-direction displacement output voltage are expressed as follows:
$$\{ \begin{matrix}{U}_{x} = {K}_{3} {K}_{4} ω {M}_{x} I \\ {U}_{y} = {K}_{3} {K}_{4} ω {M}_{y} I\end{matrix} ; \qquad ( 5 )$$
wherein K3 is a signal gain of each of the X-direction instrumentation amplifier and the Y-direction instrumentation amplifier, and K4 is a signal gain of each of the X-direction phase-sensitive detector and the Y-direction phase-sensitive detector.

7. The non-contact 3D displacement sensor according to claim 1, wherein the first target conductor and the second target conductor are both made of metal plates.

8. The non-contact 3D displacement sensor according to claim 1, wherein in an initial state, a Z-direction distance between the first differential coil and the first target conductor is equal to a Z-direction distance between the second differential coil and the second target conductor, a Y-direction distance between the pair of the first receiving coils is equal to an X-direction distance between the pair of the second receiving coils, and an intersection point of centerlines of the pair of the first receiving coils and the pair of the second receiving coils is located on a line connecting centers of the first differential coil and the second differential coil.
